(19) United States
(12) Patent Application Publication
(10) Pub. No.: US 2026/0270490 A1
(43) Pub. Date: Sep. 10, 2026

(54) INFORMATION PRESENTATION METHOD AND APPARATUS

(71) Applicant: Beijing Zitiao Network Technology Co., Ltd., Beijing (CN)

(72) Inventor: Zhengxiang WENG, Beijing (CN)

(21) Appl. No.: 19/162,896

(22) PCT Filed: Mar. 7, 2024
(86) PCT No.: PCT/CN2024/080459

§ 371 Date: Sep. 5, 2025

(30) Foreign Application Priority Data
Mar. 7, 2023 (CN) 202310220191.1

(51) Int. Cl. H04N 21/2187; H04N 21/2387; H04N 21/485

(52) U.S. Cl. CPC H04N 21/2187; H04N 21/2387; H04N 21/4854

(57) ABSTRACT

The present disclosure provides an information display method and apparatus, and the information display method includes: displaying a first live streaming video playback image in a first image ratio; and in response to a first image adjustment operation, displaying a second live streaming video playback image in the first image ratio, where image content of the second live streaming video playback image is obtained by cropping image content of the first live streaming video playback image.

The present application claims the priority to Chinese Patent Application No. 202310220191.1, filed on Mar. 7, 2023, the entire disclosure of which is incorporated herein by reference as portion of the present application.

### TECHNICAL FIELD

The present disclosure relates to an information display method and apparatus.

### BACKGROUND

With the development of the computer technology and the network technology, users can watch videos through applications.

At present, the viewing experience of videos is not very high. Therefore, there is an urgent need for a solution to address the problem.

### SUMMARY

To address or at least partially address the above problem, embodiments of the present disclosure provide an information display method and apparatus.

In a first aspect, the embodiments of the present disclosure provide an information display method, which includes:
displaying a first live streaming video playback image in a first image ratio; and displaying a second live streaming video playback image in the first image ratio in response to a first image adjustment operation, where image content of the second live streaming video playback image is obtained by cropping image content of the first live streaming video playback image.

Optionally, the image content of the first live streaming video playback image includes a first region image content and a second region image content, and the image content of the second live streaming video playback image includes the second region image content; and the image content of the second live streaming video playback image is obtained by cropping the first region image content of the first live streaming video playback image.

Optionally, a first boundary of the first live streaming video playback image in a first direction corresponds to a first position of a player region in the first direction, and a second boundary of the first live streaming video playback image in the first direction corresponds to a second position of the player region in the first direction; the first region image content includes at least one of: (i) a first boundary region corresponding to the first boundary; (ii) a second boundary region corresponding to the second boundary; and the displaying the second live streaming video playback image in the first image ratio includes:
displaying the second live streaming video playback image, with a first boundary of the second live streaming video playback image in the first direction corresponding to the first position of the player region in the first direction, and a second boundary of the second live streaming video playback image in the first direction corresponding to the second position of the player region in the first direction.

Optionally, the first boundary of the second live streaming video playback image in the first direction corresponding to the first position of the player region in the first direction, and the second boundary of the second live streaming video playback image in the first direction corresponding to the second position of the player region in the first direction are implemented by:
stretching the second region image content along the first direction, to enable that the first boundary of the second live streaming video playback image in the first direction corresponds to the first position of the player region in the first direction and the second boundary of the second live streaming video playback image in the first direction corresponds to the second position of the player region in the first direction.

Optionally, the information display method further includes:
displaying an adjusted second live streaming video playback image in response to a second image adjustment operation triggered for the second live streaming video playback image, where the second image adjustment operation is an image zoom-in operation or an image zoom-out operation; and
displaying the second live streaming video playback image in the first image ratio in response to an image restoring operation triggered for the adjusted second live streaming video playback image.

Optionally, the displaying the second live streaming video playback image in the first image ratio in response to the image restoring operation triggered for the adjusted second live streaming video playback image includes:
in response to the image restoring operation, acquiring the first image ratio pre-cached and displaying the second live streaming video playback image in the first image ratio.

Optionally, the displaying the first live streaming video playback image in the first image ratio includes:
displaying the first live streaming video playback image in the first image ratio in a landscape mode.

In a second aspect, the embodiments of the present disclosure further provide an information display apparatus, which includes:
a first display unit configured to display a first live streaming video playback image in a first image ratio; and
a second display unit configured to display a second live streaming video playback image in the first image ratio in response to a first image adjustment operation, where image content of the second live streaming video playback image is obtained by cropping image content of the first live streaming video playback image.

Optionally, the image content of the first live streaming video playback image includes a first region image content and a second region image content, and the image content of the second live streaming video playback image includes the second region image content; and the image content of the second live streaming video playback image is obtained by cropping the first region image content of the first live streaming video playback image.

Optionally, a first boundary of the first live streaming video playback image in a first direction corresponds to a first position of a player region in the first direction, and a second boundary of the first live streaming video playback image in the first direction corresponds to a second position of the player region in the first direction; the first region image content includes at least one of: (i) a first boundary region corresponding to the first boundary; (ii) a second boundary region corresponding to the second boundary; and the second display unit is configured to:
display the second live streaming video playback image, with a first boundary of the second live streaming video playback image in the first direction corresponding to the first position of the player region in the first direction, and a second boundary of the second live streaming video playback image in the first direction corresponding to the second position of the player region in the first direction.

Optionally, the first boundary of the second live streaming video playback image in the first direction corresponding to the first position of the player region in the first direction, and the second boundary of the second live streaming video playback image in the first direction corresponding to the second position of the player region in the first direction are implemented by:
stretching the second region image content along the first direction, to enable that the first boundary of the second live streaming video playback image in the first direction corresponds to the first position of the player region in the first direction and the second boundary of the second live streaming video playback image in the first direction corresponds to the second position of the player region in the first direction.

Optionally, the information display apparatus further includes:
a third display unit configured to display an adjusted second live streaming video playback image in response to a second image adjustment operation triggered for the second live streaming video playback image, where the second image adjustment operation is an image zoom-in operation or an image zoom-out operation; and
a fourth display unit configured to display the second live streaming video playback image in the first image ratio in response to an image restoring operation triggered for the adjusted second live streaming video playback image.

Optionally, the fourth display unit is configured to:
in response to the image restoring operation, acquire the first image ratio pre-cached and display the second live streaming video playback image in the first image ratio.

Optionally, the first display unit is configured to:
display the first live streaming video playback image in the first image ratio in a landscape mode.

In a third aspect, the embodiments of the present disclosure further provide a device, which includes a processor and a memory;
the processor is configured to execute instructions stored in the memory to enable the device to perform the information display method according to any embodiment of the first aspect.

In a fourth aspect, the embodiments of the present disclosure further provide a computer-readable storage medium, which includes instructions, and the instructions instruct a device to perform the information display method according to any embodiment of the first aspect.

In a fifth aspect, the embodiments of the present disclosure further provide a computer program product, and the computer program product, when executed on a computer, enables the computer to perform the information display method according to any embodiment of the first aspect.

### BRIEF DESCRIPTION OF DRAWINGS

In order to more clearly illustrate the technical solutions in the embodiments of the present disclosure, the drawings to be used in the description of the embodiments will be briefly described below. Obviously, the drawings in the following description are only some embodiments recorded in the present disclosure. For those ordinarily skilled in the art, other drawings may be obtained based on these drawings without inventive work.

FIG. 1 is a schematic flowchart of an information display method provided by the embodiments of the present disclosure;

FIG. 2a is a schematic diagram of a first live streaming video playback image provided by the embodiments of the present disclosure;

FIG. 2b is a schematic diagram of a second live streaming video playback image provided by the embodiments of the present disclosure;

FIG. 2c is a schematic diagram of another first live streaming video playback image provided by the embodiments of the present disclosure;

FIG. 2d is a schematic diagram of another second live streaming video playback image provided by the embodiments of the present disclosure; and FIG. 3 is a schematic structural diagram of an information display apparatus provided by the embodiments of the present disclosure.

### DETAILED DESCRIPTION

To enable those skilled in the art to better understand the present disclosure, the technical solutions in the embodiments of the present disclosure will be clearly and completely described below in conjunction with the drawings. Obviously, the described embodiments are merely a part of the embodiments of the present disclosure, not all of them. Based on the embodiments of the present disclosure, all other embodiments obtained by those of ordinary skill in the art without creative efforts are within the scope of protection of the present disclosure.

The various non-limiting embodiments of the present disclosure are described in detail below in conjunction with the drawings.

With reference to FIG. 1, FIG. 1 is a schematic flowchart of an information display method provided by the embodiments of the present disclosure. The information display method provided by the embodiments of the present disclosure may be applied to a client which can run on a terminal device. As an example, the information display method may, for example, include the following steps S101 to S102.

S101: displaying a first live streaming video playback image in a first image ratio.

S102: displaying a second live streaming video playback image in the first image ratio in response to a first image adjustment operation, where image content of the second live streaming video playback image is obtained by cropping image content of the first live streaming video playback image.

The embodiments of the present disclosure provide an information display method, which includes: displaying a first live streaming video playback image in a first image ratio; and displaying a second live streaming video playback image in the first image ratio in response to a first image adjustment operation, where image content of the second live streaming video playback image is obtained by cropping image content of the first live streaming video playback image. Thus, with the method, users can trigger the first image adjustment operation such that the image content of the first live streaming video playback image is cropped, and the display ratio of the second live streaming video playback image is maintained as the first image ratio, enabling users to efficiently acquire video content information and enhancing their video viewing experience.

The embodiments of the present disclosure do not limit the image content included in the first live streaming video playback image. In an example, the image content of the first live streaming video playback image may include game live streaming.

In an example, the client may display the first live streaming video playback image in a landscape mode.

The embodiments of the present disclosure do not limit the first image ratio. The first image ratio may be determined according to actual situations.

The user may trigger the first image adjustment operation for the first live streaming video playback image. The first image adjustment operation may be triggered by a corresponding control or a gesture, which will not be limited in the embodiments of the present disclosure.

In the embodiments of the present disclosure, the client may crop the first live streaming video playback image in response to the first image adjustment operation and display the cropped second live streaming video playback image in the first image ratio.

In the embodiments of the present disclosure, the image content of the first live streaming video playback image may include a first region image content and a second region image content. In an example, the second region image content includes key elements of a live streaming video. The key elements mentioned here include, but are not limited to, an explanation object, a streamer image, and an interactive control in the live streaming video. The first region image content may be non-key elements, i.e., content other than the above-mentioned key elements. For example, the first region image content is an advertisement, and the second region image content is a game live streaming video. The content displayed in a first region is the advertisement. In this case, the image content of the second live streaming video playback image may include the second region image content. The image content of the second live streaming video playback image may be obtained by cropping the first live streaming video playback image.

In an example, the client determines that the first region image content is the non-key element after receiving the first image adjustment operation. Therefore, the client may crop the first region image content to obtain the second region image content and further obtain the second live streaming video playback image based on the second region image content.

In another example, the client may determine the first region image content according to image cropping configuration information, then crop the first region image content to obtain the second region image content, and further obtain the second live streaming video playback image based on the second region image content.

In an example, a first boundary of the first live streaming video playback image in a first direction corresponds to a first position of a player region in the first direction, and a second boundary of the first live streaming video playback image in the first direction corresponds to a second position of the player region in the first direction. The first direction may be a direction from the first boundary to the second boundary, or a direction from the second boundary to the first boundary. In this case, the first region image content includes a first boundary region corresponding to the first boundary and/or a second boundary region corresponding to the second boundary. Correspondingly, a first boundary of the second live streaming video playback image in the first direction corresponds to the first position of the player region in the first direction, and a second boundary of the second live streaming video playback image in the first direction corresponds to the second position of the player region in the first direction. In other words, after cropping the first region image content, the size of the displayed image of the second region image content is identical to the size of the first live streaming video playback image, so that users can view the key elements in the first live streaming video image more intuitively without being disturbed by other content.

In an example, the client may stretch the cropped second region image content after cropping the first region image content such that the image size of the stretched second live streaming video image is identical to the image size of the first live streaming video playback image. In an example, the client may determine an image stretching direction as the first direction according to the position of the first region image content in the first live streaming video playback image, and further stretch the second region image content based on the first direction such that the first boundary of the second live streaming video playback image in the first direction corresponds to the first position of the player region in the first direction, and the second boundary of the second live streaming video playback image in the first direction corresponds to the second position of the player region in the first direction.

In an example, the first direction may be a horizontal direction; the first boundary of the first live streaming video playback image in the first direction may be the left boundary of the first live streaming video playback image; and the second boundary of the first live streaming video playback image in the first direction may be the right boundary of the first live streaming video playback image. Correspondingly, the first boundary region may be a left region of the first live streaming video image, and the second boundary region may be a right region of the first live streaming video image. In this case, the client may stretch the cropped second region image content in the horizontal direction after cropping the left region and/or the right region of the first live streaming video playback image, so that the left boundary of the second live streaming video playback image corresponds to the above-mentioned first position and the right boundary of the second live streaming video playback image corresponds to the above-mentioned second position.

In another example, the first direction may be a vertical direction; the first boundary of the first live streaming video playback image in the first direction may be the upper boundary of the first live streaming video playback image; and the second boundary of the first live streaming video playback image in the first direction may be the lower boundary of the first live streaming video playback image. Correspondingly, the first boundary region may be a top region of the first live streaming video image, and the second boundary region may be a bottom region of the first live streaming video image. In this case, the client may stretch the cropped second region image content in the vertical direction after cropping the top region and/or the bottom region of the first live streaming video playback image, so that the left boundary of the second live streaming video playback image corresponds to the above-mentioned first position and the right boundary of the second live streaming video playback image corresponds to the above-mentioned second position.

The embodiments of the present disclosure have no limitations on the first position and the second position. In an example, if the first direction is the horizontal direction, the first position may be the position of the left boundary of the player region, and the second position may be the position of the right boundary of the player region. In another example, if the first direction is the vertical direction, the first position may be the position of the upper boundary of the player region, and the second position may be the position of the lower boundary of the player region.

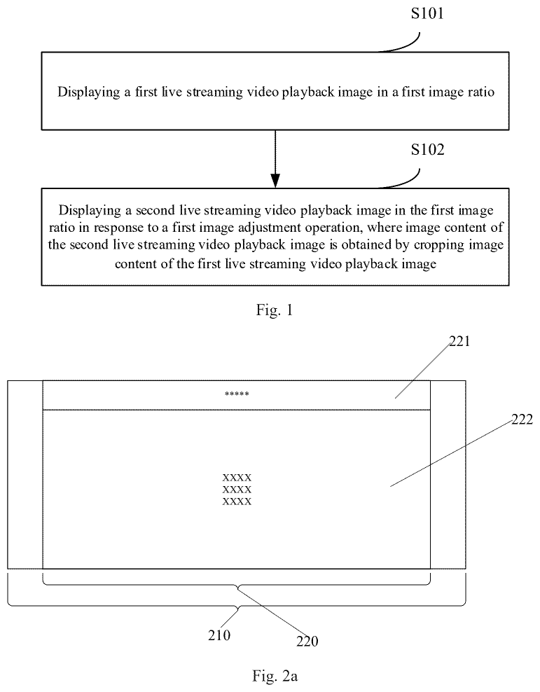

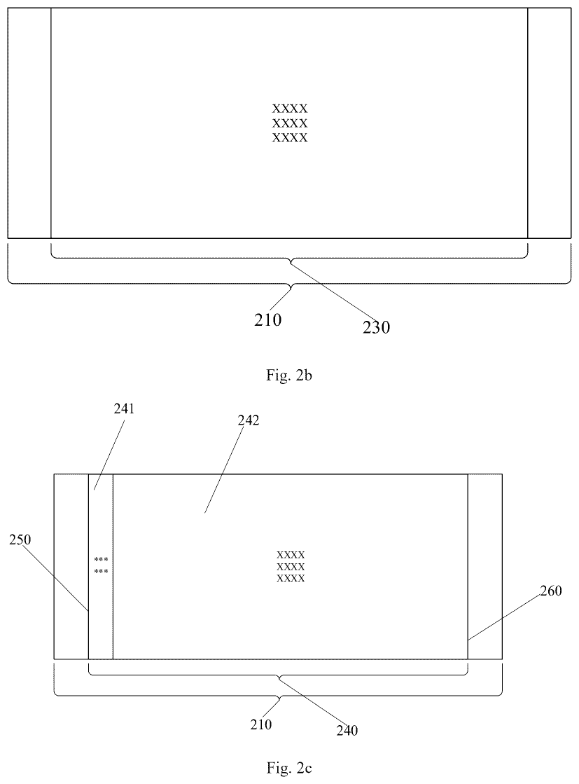

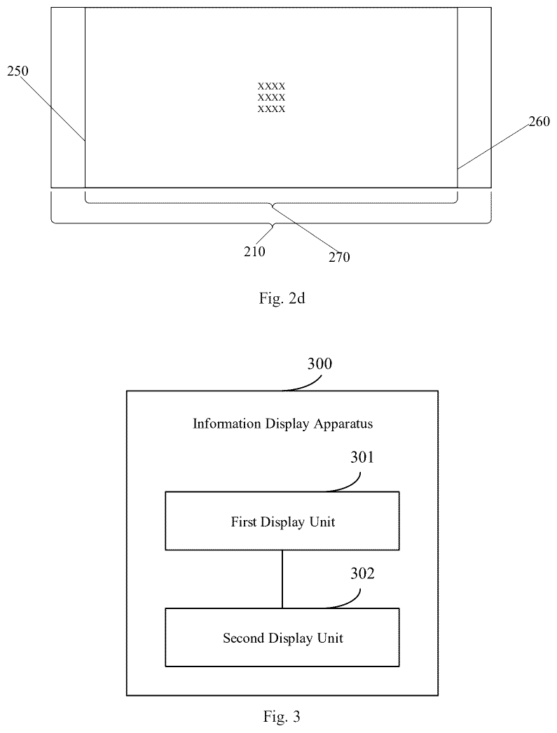

In an example, with reference to FIG. 2a, FIG. 2a is a schematic diagram of a first live streaming video playback image provided by the embodiments of the present disclosure. As shown in FIGS. 2a, 210 denotes a player region, and 220 denotes the first live streaming video playback image. The upper boundary of the first live streaming video playback image 220 is aligned with the upper boundary of the player region 210, and the lower boundary of the first live streaming video playback image 220 is aligned with the lower boundary of the player region 210. A first region image content 221 of the first live streaming video playback image 220 is located at the top of the first live streaming video playback image 220. After the first live streaming video playback image 220 is cropped, the second live streaming video playback image displayed by the client may be shown in FIG. 2b, and the upper boundary of the second live streaming video playback image 230 is aligned with the upper boundary of the player region 210, while the lower boundary of the second live streaming video playback image 230 is aligned with the lower boundary of the player region 210. In FIG. 2a and FIG. 2b, the content included in the first region image content 221 is denoted by “***”, and the content included in a second region image content 222 is denoted by “XXX”.

In another example, with reference to FIG. 2c, FIG. 2c is a schematic diagram of a first live streaming video playback image provided by the embodiments of the present disclosure. As shown in FIGS. 2c, 210 denotes a player region, and 240 denotes the first live streaming video playback image. The left boundary of the first live streaming video playback image 240 is aligned with a first position 250 of the player region 210, and the right boundary of the first live streaming video playback image 240 is aligned with a second position 260 of the player region 210. A first region image content 241 of the first live streaming video playback image 240 is located in a left region of the first live streaming video playback image 220. After the first live streaming video playback image 240 is cropped, the second live streaming video playback image displayed by the client may be as shown in FIG. 2d, and the left boundary of the second live streaming video playback image 270 is aligned with the first position 250 of the player region 210, and the right boundary of the second live streaming video playback image 270 is aligned with the second position 260 of the player region 210.

In FIG. 2c and FIG. 2d, the content included in the first region image content 241 is denoted by “***”, and the content included in a second region image content 242 is denoted by “XXX”.

FIG. 2a to FIG. 2d are illustrated only for the purpose of facilitating understanding of the embodiments and do not constitute limitations on the embodiments of the present disclosure.

After the client displays the second live streaming video playback image, to further enhance the viewing experience, the second live streaming video playback image may also support image zooming in or image zooming out. In an example, users may trigger a second image adjustment operation for the second live streaming video playback image, and the second image adjustment operation is an image zoom-in operation or an image zoom-out operation. Correspondingly, the client may display the adjusted second live streaming video playback image in response to the second image adjustment operation. In an example, users may perform the second image adjustment operation once, or may continuously perform the second image adjustment operation for multiple times, which will not be limited in the embodiments of the present disclosure.

In an example, considering that users may wish to restore the image ratio of the second live streaming video playback image to the initial first image ratio after performing the second image adjustment operation, in an example, after the client displays the adjusted second live streaming video playback image, users may trigger an image restoring operation for the adjusted second live streaming video playback image. For example, users may trigger the image restoring operation by a corresponding gesture or interactive control, which will not be limited in the embodiments of the present disclosure. Correspondingly, the client may display the second live streaming video playback image in the first image ratio in response to the image restoring operation. In this case, users can trigger the image restoring operation such that the client rapidly restores the image ratio of the second live streaming video playback image to the first image ratio.

In an example, the client may cache the first image ratio. For example, the client caches the first image ratio after receiving the first image adjustment operation. In this case, the client may acquire the cached first image ratio after receiving the image restoring operation, to display the second live streaming video playback image in the first image ratio, thereby achieving the effect of rapidly restoring the image ratio of the second live streaming video playback image to the first image ratio.

In an example, the image zoom-in operation and the image zoom-out operation may both be triggered by two fingers. In this case, in an example, the client may determine the image zoom-in operation or the image zoom-out operation through an application programming interface provided by an operating system. In an example, if the number of fingers touching the screen is determined to be 2 through the application programming interface and the distance between the two fingers touching the screen is increased continuously, it may be determined that the operation triggered by the user using two fingers is the image zoom-in operation. In another example, if the number of fingers touching the screen is determined to be 2 through the application programming interface and the distance between the two fingers touching the screen is decreased continuously, it may be determined that the operation triggered by the user using two fingers is the image zoom-out operation.

Based on the method provided by the above-mentioned embodiment, the embodiments of the present disclosure further provide an apparatus which will be described below with reference to the drawing.

With reference to FIG. 3, FIG. 3 is a schematic structural diagram of an information display apparatus provided by the embodiments of the present disclosure. The information display apparatus 300 shown in FIG. 3 includes a first display unit 301 and a second display unit 302.

The first display unit 301 is configured to display a first live streaming video playback image in a first image ratio.

The second display unit 302 is configured to display a second live streaming video playback image in the first image ratio in response to a first image adjustment operation, and the image content of the second live streaming video playback image is obtained by cropping the image content of the first live streaming video playback image.

Optionally, the image content of the first live streaming video playback image includes a first region image content and a second region image content, and the image content of the second live streaming video playback image includes the second region image content; and the image content of the second live streaming video playback image is obtained by cropping the first region image content of the first live streaming video playback image.

Optionally, a first boundary of the first live streaming video playback image in a first direction corresponds to a first position of a player region in the first direction, and a second boundary of the first live streaming video playback image in the first direction corresponds to a second position of the player region in the first direction; the first region image content includes a first boundary region corresponding to the first boundary and/or a second boundary region corresponding to the second boundary; and the second display unit 302 is configured to:
display the second live streaming video playback image, with a first boundary of the second live streaming video playback image in the first direction corresponding to the first position of the player region in the first direction and a second boundary of the second live streaming video playback image in the first direction corresponding to the second position of the player region in the first direction.

Optionally, the first boundary of the second live streaming video playback image in the first direction corresponding to the first position of the player region in the first direction and the second boundary of the second live streaming video playback image in the first direction corresponding to the second position of the player region in the first direction include:
stretching the second region image content along the first direction, to enable that the first boundary of the second live streaming video playback image in the first direction corresponds to the first position of the player region in the first direction and the second boundary of the second live streaming video playback image in the first direction corresponds to the second position of the player region in the first direction.

Optionally, the information display apparatus further includes:
a third display unit configured to display an adjusted second live streaming video playback image in response to a second image adjustment operation triggered for the second live streaming video playback image, where the second image adjustment operation is an image zoom-in operation or an image zoom-out operation; and
a fourth display unit configured to display the second live streaming video playback image in the first image ratio in response to an image restoring operation triggered for the adjusted second live streaming video playback image.

Optionally, the fourth display unit is configured to:
in response to the image restoring operation, acquire the first image ratio pre-cached, and display the second live streaming video playback image in the first image ratio.

Optionally, the first display unit 301 is configured to:
display the first live streaming video playback image in the first image ratio in a landscape mode.

Because the apparatus 300 corresponds to the information display method provided in the above-mentioned method embodiments, the specific implementation of each unit of the apparatus 300 is based on the same concept as the above-mentioned method embodiments. Therefore, the specific implementation of each unit of the apparatus 300 may be referenced from the relevant description of the above-mentioned method embodiments and will not be redundantly described here.

The embodiments of the present disclosure further provide a device including a processor and a memory.

The processor is configured to execute instructions stored in the memory to enable the device to perform the information display method according to any one of the above-mentioned method embodiments.

The embodiments of the present disclosure further provide a computer-readable storage medium including instructions that instruct a device to perform the information display method according to any one of the above-mentioned method embodiments.

The embodiments of the present disclosure further provide a computer program product, and the computer program product, when executed on a computer, enables the computer to perform the information display method according to any one of the above-mentioned method embodiments.

Other embodiments of the present disclosure will be readily apparent to those skilled in the art from consideration of the present disclosure. The present disclosure is intended to cover any variations, uses, or adaptations of the disclosure that follow the general principles of the present disclosure and include common knowledge or customary technical means in the art that are not disclosed in the present disclosure. The embodiments of the present disclosure are to be regarded as exemplary only, and the true scope and spirit of the present disclosure is indicated by the following claims.

It should be understood that the present disclosure is not limited to the precise structure described above and illustrated in the drawings, and various modifications and changes may be made without departing from the scope thereof. The scope of the present disclosure is limited only by the appended claims.

The above are only preferred embodiments of the present disclosure and are not intended to limit the present disclosure, and any modifications, equivalent substitutions, improvements, etc. made within the spirit and principles of the present disclosure shall be included in the scope of protection of the present disclosure.

1. An information display method, comprising:
displaying a first live streaming video playback image in a first image ratio; and
displaying a second live streaming video playback image in the first image ratio in response to a first image adjustment operation, wherein image content of the second live streaming video playback image is obtained by cropping image content of the first live streaming video playback image.

2. The information display method according to claim 1, wherein the image content of the first live streaming video playback image comprises a first region image content and a second region image content, and the image content of the second live streaming video playback image comprises the second region image content; and
the image content of the second live streaming video playback image is obtained by cropping the first region image content of the first live streaming video playback image.

3. The information display method according to claim 2, wherein a first boundary of the first live streaming video playback image in a first direction corresponds to a first position of a player region in the first direction, and a second boundary of the first live streaming video playback image in the first direction corresponds to a second position of the player region in the first direction;
the first region image content comprises at least one of: (i) a first boundary region corresponding to the first boundary; (ii) a second boundary region corresponding to the second boundary; and
the displaying the second live streaming video playback image in the first image ratio comprises:
displaying the second live streaming video playback image, with a first boundary of the second live streaming video playback image in the first direction corresponding to the first position of the player region in the first direction, and a second boundary of the second live streaming video playback image in the first direction corresponding to the second position of the player region in the first direction.

4. The information display method according to claim 3, wherein the first boundary of the second live streaming video playback image in the first direction corresponding to the first position of the player region in the first direction, and the second boundary of the second live streaming video playback image in the first direction corresponding to the second position of the player region in the first direction are implemented by:
stretching the second region image content along the first direction, to enable that the first boundary of the second live streaming video playback image in the first direction corresponds to the first position of the player region in the first direction and the second boundary of the second live streaming video playback image in the first direction corresponds to the second position of the player region in the first direction.

5. The information display method according to claim 1, further comprising:
displaying an adjusted second live streaming video playback image in response to a second image adjustment operation triggered for the second live streaming video playback image, wherein the second image adjustment operation is an image zoom-in operation or an image zoom-out operation; and
displaying the second live streaming video playback image in the first image ratio in response to an image restoring operation triggered for the adjusted second live streaming video playback image.

6. The information display method according to claim 5, wherein the displaying the second live streaming video playback image in the first image ratio in response to the image restoring operation triggered for the adjusted second live streaming video playback image comprises:
in response to the image restoring operation, acquiring the first image ratio pre-cached and displaying the second live streaming video playback image in the first image ratio.

7. The information display method according to claim 1, wherein the displaying the first live streaming video playback image in the first image ratio comprises:
displaying the first live streaming video playback image in the first image ratio in a landscape mode.

8. (canceled)

9. A device, comprising a processor and a memory,
wherein the processor is configured to execute instructions stored in the memory to enable the device to perform an information display method,
and the information display method comprises:
displaying a first live streaming video playback image in a first image ratio; and
displaying a second live streaming video playback image in the first image ratio in response to a first image adjustment operation, wherein image content of the second live streaming video playback image is obtained by cropping image content of the first live streaming video playback image.

10. A non-transitory computer-readable storage medium, comprising instructions, wherein the instructions instruct a device to perform an information display method, and the information display method comprises:
displaying a first live streaming video playback image in a first image ratio; and
displaying a second live streaming video playback image in the first image ratio in response to a first image adjustment operation, wherein image content of the second live streaming video playback image is obtained by cropping image content of the first live streaming video playback image.

11. The device according to claim 9, wherein the image content of the first live streaming video playback image comprises a first region image content and a second region image content, and the image content of the second live streaming video playback image comprises the second region image content; and
the image content of the second live streaming video playback image is obtained by cropping the first region image content of the first live streaming video playback image.

12. The device according to claim 11, wherein a first boundary of the first live streaming video playback image in a first direction corresponds to a first position of a player region in the first direction, and a second boundary of the first live streaming video playback image in the first direction corresponds to a second position of the player region in the first direction;
the first region image content comprises at least one of: (i) a first boundary region corresponding to the first boundary; (ii) a second boundary region corresponding to the second boundary; and
the displaying the second live streaming video playback image in the first image ratio comprises:
displaying the second live streaming video playback image, with a first boundary of the second live streaming video playback image in the first direction corresponding to the first position of the player region in the first direction, and a second boundary of the second live streaming video playback image in the first direction corresponding to the second position of the player region in the first direction.

13. The device according to claim 12, wherein the first boundary of the second live streaming video playback image in the first direction corresponding to the first position of the player region in the first direction, and the second boundary of the second live streaming video playback image in the first direction corresponding to the second position of the player region in the first direction are implemented by:
stretching the second region image content along the first direction, to enable that the first boundary of the second live streaming video playback image in the first direction corresponds to the first position of the player region in the first direction and the second boundary of the second live streaming video playback image in the first direction corresponds to the second position of the player region in the first direction.

14. The device according to claim 9, wherein the information display method further comprises:
displaying an adjusted second live streaming video playback image in response to a second image adjustment operation triggered for the second live streaming video playback image, wherein the second image adjustment operation is an image zoom-in operation or an image zoom-out operation; and
displaying the second live streaming video playback image in the first image ratio in response to an image restoring operation triggered for the adjusted second live streaming video playback image.

15. The device according to claim 14, wherein the displaying the second live streaming video playback image in the first image ratio in response to the image restoring operation triggered for the adjusted second live streaming video playback image comprises:
in response to the image restoring operation, acquiring the first image ratio pre-cached and displaying the second live streaming video playback image in the first image ratio.

16. The device according to claim 9, wherein the displaying the first live streaming video playback image in the first image ratio comprises:
displaying the first live streaming video playback image in the first image ratio in a landscape mode.

17. The non-transitory computer-readable storage medium according to claim 10, wherein the image content of the first live streaming video playback image comprises a first region image content and a second region image content, and the image content of the second live streaming video playback image comprises the second region image content; and
the image content of the second live streaming video playback image is obtained by cropping the first region image content of the first live streaming video playback image.

18. The non-transitory computer-readable storage medium according to claim 17, wherein a first boundary of the first live streaming video playback image in a first direction corresponds to a first position of a player region in the first direction, and a second boundary of the first live streaming video playback image in the first direction corresponds to a second position of the player region in the first direction;
the first region image content comprises at least one of: (i) a first boundary region corresponding to the first boundary; (ii) a second boundary region corresponding to the second boundary; and
the displaying the second live streaming video playback image in the first image ratio comprises:
displaying the second live streaming video playback image, with a first boundary of the second live streaming video playback image in the first direction corresponding to the first position of the player region in the first direction, and a second boundary of the second live streaming video playback image in the first direction corresponding to the second position of the player region in the first direction.

19. The non-transitory computer-readable storage medium according to claim 18, wherein the first boundary of the second live streaming video playback image in the first direction corresponding to the first position of the player region in the first direction, and the second boundary of the second live streaming video playback image in the first direction corresponding to the second position of the player region in the first direction are implemented by:
stretching the second region image content along the first direction, to enable that the first boundary of the second live streaming video playback image in the first direction corresponds to the first position of the player region in the first direction and the second boundary of the second live streaming video playback image in the first direction corresponds to the second position of the player region in the first direction.

20. The non-transitory computer-readable storage medium according to claim 10, wherein the information display method further comprises:
displaying an adjusted second live streaming video playback image in response to a second image adjustment operation triggered for the second live streaming video playback image, wherein the second image adjustment operation is an image zoom-in operation or an image zoom-out operation; and
displaying the second live streaming video playback image in the first image ratio in response to an image restoring operation triggered for the adjusted second live streaming video playback image.

21. The non-transitory computer-readable storage medium according to claim 20, wherein the displaying the second live streaming video playback image in the first image ratio in response to the image restoring operation triggered for the adjusted second live streaming video playback image comprises:
in response to the image restoring operation, acquiring the first image ratio pre-cached and displaying the second live streaming video playback image in the first image ratio.
